(19) United States
(12) Patent Application Publication
(10) Pub. No.: US 2014/0054994 A1
(43) Pub. Date: Feb. 27, 2014

(54) HYDRODYNAMIC BEARING MODULE AND SPINDLE MOTOR HAVING THE SAME

(71) Applicant: SAMSUNG ELECTRO-MECHANICS CO., LTD., Suwon (KR)

(72) Inventor: Sang Sun Kang, Suwon (KR)

(73) Assignee: SAMSUNG ELECTRO-MECHANICS CO., LTD., Suwon (KR)

(21) Appl. No.: 13/968,032

(22) Filed: Aug. 15, 2013

(30) Foreign Application Priority Data
Aug. 23, 2012 (KR) 10-2012-0092480

(51) Int. Cl. F16C 32/06; H02K 7/08

(52) U.S. Cl. CPC F16C 32/0629; H02K 7/085
USPC 310/90; 384/107

(57) ABSTRACT

Disclosed herein is a hydrodynamic bearing module including: a hydrodynamic bearing part formed by filling oil in a micro-clearance between a rotating part and a fixed part including a sleeve; a first radial dynamic pressure bearing part formed in a micro-clearance between an inner diameter portion of the sleeve and the rotating part; a second radial dynamic pressure bearing part formed in a micro-clearance between an outer diameter portion of the sleeve and the rotating part; and a thrust dynamic pressure bearing part formed between the sleeve and the rotating part and positioned between the first and second radial dynamic pressure bearing parts.

### CROSS REFERENCE TO RELATED APPLICATION

This application claims the benefit of Korean Patent Application No. 10-2012-0092480, filed on Aug. 23, 2012, entitled “Hydrodynamic Bearing Module and Spindle Motor Having the Same”, which is hereby incorporated by reference in its entirety into this application.

### BACKGROUND OF THE INVENTION

1. Technical Field

The present invention relates to a hydrodynamic bearing module and a spindle motor having the same.

2. Description of the Related Art

Generally, in a spindle motor used as a driving device of a recording disk such as a hard disk, or the like, a hydrodynamic bearing using dynamic pressure generated by a lubricating fluid such as oil, or the like, stored between a rotating part and a fixed part at the time of rotation of the motor has been widely used.

More specifically, since the spindle motor including the hydrodynamic bearing that maintains shaft rigidity of a shaft only by movable pressure of the lubricating oil by centrifugal force is based on centrifugal force, metal friction does not occur and stability increases as a rotation speed increases, such that the generation of noise and vibration decreases and a rotating object can be more readily rotated at a high speed as compared with a motor having a ball bearing. As a result, the spindle motor has been mainly applied to a high end optical disk device, a high end magnetic disk device, or the like.

However, a spindle motor having a hydrodynamic bearing module according to the prior art including the following prior art document (Patent Document) has disadvantages such as weak shaft rigidity and oil leakage.

### PRIOR ART DOCUMENT

### Patent Document

(Patent Document 1) Japanese Patent Laid-Open Publication No. 2003-304664

### SUMMARY OF THE INVENTION

The present invention has been made in an effort to provide a hydrodynamic bearing module capable of improving a sealing effect of oil and securing rigidity of an outer diameter portion of a to sleeve by forming radial dynamic pressure bearing parts at inner and outer diameter portions of the sleeve, respectively, and forming a thrust dynamic pressure bearing part between the radial dynamic pressure bearing parts, and a spindle motor having the same.

Further, the present invention has been made in an effort to provide a hydrodynamic bearing module capable of having a more stable and efficient hydrodynamic bearing structure by forming an oil circulation hole between radial dynamic pressure bearing parts, and a spindle motor having the same.

According to a preferred embodiment of the present invention, there is provided a hydrodynamic bearing module including: a hydrodynamic bearing part formed by filling oil in a micro-clearance between a rotating part and a fixed part including a sleeve; a first radial dynamic pressure bearing part formed in a micro-clearance between an inner diameter portion of the sleeve and the rotating part; a second radial dynamic pressure bearing part formed in a micro-clearance between an outer diameter portion of the sleeve and the rotating part; and a thrust dynamic pressure bearing part formed between the sleeve and the rotating part and positioned between the first and second radial dynamic pressure bearing parts.

The first radial dynamic pressure bearing part may include an upper first radial dynamic pressure bearing part and a lower first radial dynamic pressure bearing part formed in an axial direction, and the second radial dynamic pressure bearing part may include an upper second radial dynamic pressure bearing part and a lower second radial dynamic pressure bearing part formed in the axial direction.

The hydrodynamic bearing module may further include an oil circulation hole connecting between the upper first radial dynamic pressure bearing part and the lower first radial dynamic pressure bearing part and between the upper second radial dynamic pressure bearing part and the lower second radial dynamic pressure bearing part.

The rotating part may include a shaft rotatably supported by the sleeve and a hub coupled to an upper portion of the shaft and positioned to face an upper surface of the sleeve, the first radial dynamic pressure bearing part may be formed in a micro-clearance between the shaft and the sleeve in a radial direction of the shaft, the second radial dynamic pressure bearing part may be formed in a micro-clearance between the hub and the sleeve in the radial direction of the shaft, and the thrust dynamic pressure bearing part may be formed in a micro-clearance between the hub and the sleeve in an axial direction of the shaft.

According to another preferred embodiment of the present invention, there is provided a spindle motor having a hydrodynamic bearing module, including: a rotating part including a shaft, a hub coupled to the shaft, and a magnet coupled to the hub; and a fixed part including an armature facing the magnet and including a core and a coil, a sleeve rotatably supporting the shaft, and a base coupled to the sleeve and having the armature mounted thereon, wherein the hydrodynamic bearing module includes: a hydrodynamic bearing formed between the rotating part and the fixed part by filling the oil, which is an operating fluid, therein, a first radial dynamic pressure bearing part formed in a micro-clearance between an inner diameter portion of the sleeve and the shaft, a second radial dynamic pressure bearing part formed in a micro-clearance between an outer diameter portion of the sleeve and the hub, and a thrust dynamic pressure bearing part formed between the sleeve and the hub in an axial direction of the shaft and positioned between the first and second radial dynamic pressure bearing parts.

The first radial dynamic pressure bearing part may include an upper first radial dynamic pressure bearing part and a lower first radial dynamic pressure bearing part formed in the axial direction, and the second radial dynamic pressure bearing part may include an upper second radial dynamic pressure bearing part and a lower second radial dynamic pressure bearing part formed in the axial direction.

The hydrodynamic bearing module may further include an oil circulation hole connecting between the upper first radial dynamic pressure bearing part and the lower first radial dynamic pressure bearing part and between the upper second radial dynamic pressure bearing part and the lower second radial dynamic pressure bearing part.

The hub may include: a cylindrical part facing the shaft; a disk part extended from the cylindrical part in an outer diameter direction and having an outer diameter portion of the sleeve fixed thereto; a sidewall part extended downwardly from an end portion of the disk part in the outer diameter direction in the axial direction of the shaft; and a sealing part facing the outer diameter portion of the sleeve at the disk part and extended downwardly in the axial direction of the shaft.

The second radial dynamic pressure bearing part may be formed in a micro-clearance between the sealing part of the hub and the outer diameter portion of the sleeve.

First radial dynamic pressure generation grooves may be selectively formed in the inner diameter portion of the sleeve or an outer diameter portion of the shaft facing the inner diameter portion of the sleeve in order to form the first radial dynamic pressure bearing part.

Second radial dynamic pressure generation grooves may be selectively formed in the outer diameter portion of the sleeve or the sealing part of the hub facing the outer diameter portion of the sleeve in order to form the second radial dynamic pressure bearing part.

A thrust dynamic pressure generation groove may be selectively formed in the sleeve or one surface of the hub facing the sleeve in the axial direction of the shaft in order to form the thrust dynamic pressure bearing part.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view schematically showing a hydrodynamic bearing module according to a preferred embodiment of the present invention; and

FIG. 2 is a cross-sectional view schematically showing a spindle motor having the hydrodynamic bearing module according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

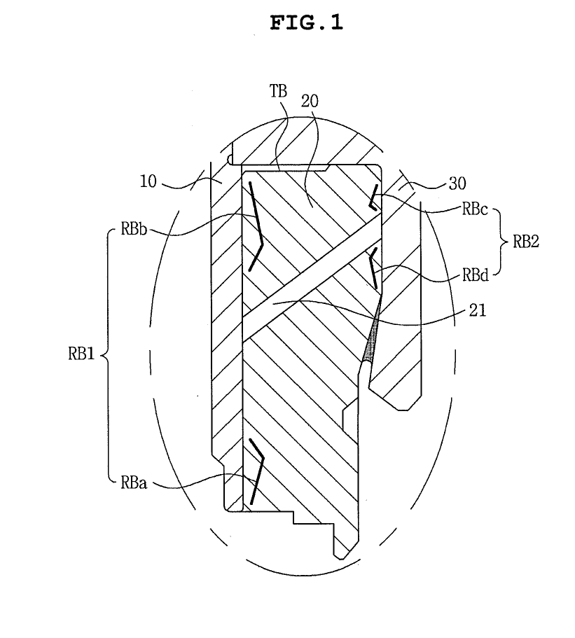

FIG. 1 is a cross-sectional view schematically showing a hydrodynamic bearing module according to a preferred embodiment of the present invention. As shown in FIG. 1, the hydrodynamic bearing module includes a hydrodynamic bearing part formed by filling oil in a micro-clearance between a rotating part and a fixed part.

More specifically, the fixed part includes a sleeve 20, and the rotating part includes a shaft 10 rotatably supported by the sleeve and a hub 30 coupled to an upper portion of the shaft 10 and positioned to face an upper surface of the sleeve.

In addition, a first radial dynamic pressure bearing part RB1 is formed in a micro-clearance between an inner diameter portion of the sleeve 20 and a shaft 10, which is the rotating part, and a second radial dynamic pressure bearing part RB2 is formed in a micro-clearance between an outer diameter portion of the sleeve 20 and the hub 30, which is the rotating part.

That is, the first radial dynamic pressure bearing part RB1 is formed in a micro-clearance between the shaft and the sleeve in a radial direction of the shaft 10, and the second radial dynamic pressure bearing part RB2 is formed in a micro-clearance between the hub 30 and the sleeve 20 in the radial direction of the shaft 10.

In addition, a thrust dynamic pressure bearing part TB is formed between the sleeve 20 and the rotating part. That is, the thrust dynamic pressure bearing part TB is formed in a micro-clearance between the hub 30 and the sleeve 20 in an axial direction of the shaft 10.

In addition, the thrust dynamic pressure bearing part TB is positioned between the first and second radial dynamic pressure bearing parts RB1 and RB2.

In addition, the first radial dynamic pressure bearing part RB1 includes an upper first radial dynamic pressure bearing part RBb and a lower first radial dynamic pressure bearing part RBa formed in the axial direction of the shaft 10, and the second radial dynamic pressure bearing part RB2 includes an upper second radial dynamic pressure bearing part RBc and a lower second radial dynamic pressure bearing part RBd formed in the axial direction of the shaft 10.

In addition, an oil circulation hole 21 connecting between the upper first radial dynamic pressure bearing part RBb and the lower first radial dynamic pressure bearing part RBa and between the upper second radial dynamic pressure bearing part RBc and the lower second radial dynamic pressure bearing part RBd is formed.

In addition, the hydrodynamic bearing module according to the preferred embodiment of the present invention includes dynamic pressure generation grooves formed in order to form the radial dynamic pressure bearing part and the thrust dynamic pressure bearing part, respectively.

Through the above-mentioned configuration, in the hydrodynamic bearing module according to the preferred embodiment of the present invention, the radial dynamic pressure bearing parts are formed at the inner and outer diameter portions of the sleeve, respectively, and the trust dynamic pressure bearing part is formed between the radial dynamic pressure bearing parts, thereby making it possible to improve a sealing effect of oil and secure rigidity of the outer diameter portion of the sleeve. In addition, the oil circulation hole is formed between the radial dynamic pressure bearing parts, thereby making it possible to have a more stable and efficient hydrodynamic bearing structure.

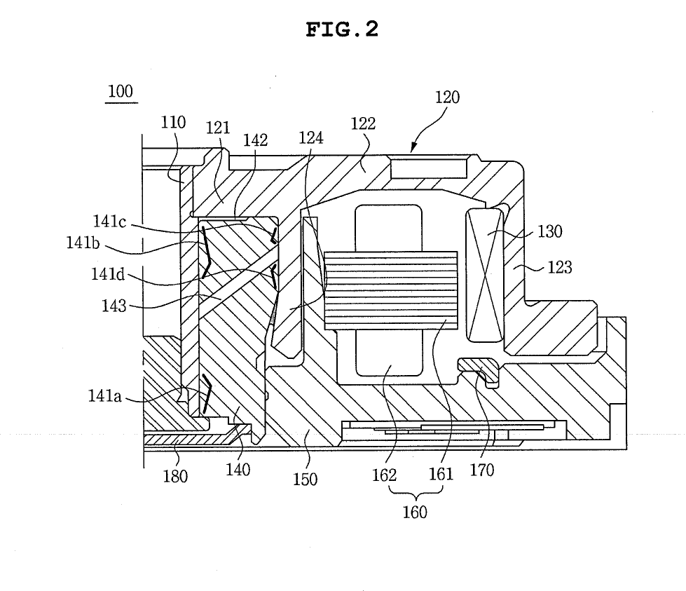

FIG. 2 is a cross-sectional view schematically showing a spindle motor having the hydrodynamic bearing module according to the preferred embodiment of the present invention. As shown in FIG. 2, the spindle motor 100 is configured to include a rotating part including a shaft 110, a hub 120, and a magnet 130; and a fixed part including a sleeve 140, an armature 160 including a core 161 and a coil 162, and a base 150, wherein a hydrodynamic bearing is formed between the rotating part and the fixed part by filling the oil, which is an operating fluid, therein.

More specifically, in the rotating part, the shaft 110 is rotatably supported by the sleeve. In addition, the hub 120 is coupled to an upper end portion of the shaft and is positioned to face an upper surface of the sleeve.

In addition, the hub 120 includes a cylindrical part 121 coupled to the upper end portion of the shaft of the sleeve 140, a disk part 122 extended from the cylindrical part 121 in an outer diameter direction, a sidewall part 123 extended downwardly from an end portion of the disk part 122 in the outer diameter direction in the axial direction of the shaft, and a sealing part 124 facing an outer diameter portion of the sleeve at the disk part 122 and extended downwardly in the axial direction of the shaft.

In addition, the sidewall part 123 includes an annular ring shaped magnet 130 mounted on an inner peripheral surface thereof so as to face an armature 160 including a core 161 and a coil 162.

Next, in the fixed part, the sleeve 140 rotatably supports the shaft, a first radial dynamic pressure bearing part is formed in a micro-clearance between an inner diameter portion of the sleeve 140 and the shaft 110, and a second radial dynamic pressure bearing part is formed in a micro-clearance between an outer diameter portion of the sleeve 140 and the sealing part 124 of the hub.

In addition, radial dynamic pressure generation grooves 141a and 141b are formed in order to form the first radial dynamic pressure bearing part, and radial dynamic pressure generation grooves 141c and 141d are formed in order to form the second radial dynamic pressure bearing part.

In addition, a trust dynamic pressure bearing part is formed between the sleeve 140 and the hub 120 in the axial direction of the shaft 110 and is positioned the first and second radial dynamic pressure bearing parts.

Further, a thrust dynamic pressure generation groove 142 is selectively formed in the sleeve or one surface of the hub facing the sleeve in the axial direction of the shaft in order to form the thrust dynamic pressure bearing part. According to the preferred embodiment of the present invention, FIG. 2 shows that the trust dynamic pressure generation groove 142 is formed in the sleeve.

In addition, the first radial dynamic pressure bearing part includes an upper first radial dynamic pressure bearing part and a lower first radial dynamic pressure bearing part formed in the axial direction, and the second radial dynamic pressure bearing part includes an upper second radial dynamic pressure bearing part and a lower second radial dynamic pressure bearing part formed in the axial direction. Further, first radial dynamic pressure generation grooves are selectively formed in an inner diameter portion of the sleeve 140 or an outer diameter portion of the shaft 110 facing the inner diameter portion of the sleeve 140 in order to form the first radial dynamic pressure bearing part, and second radial dynamic pressure generation grooves are selectively formed in an outer diameter portion of the sleeve or a sealing part of the hub facing the outer diameter portion of the sleeve in order to form the second radial dynamic pressure bearing part.

According to the preferred embodiment of the present invention, FIG. 2 shows that the first radial dynamic pressure generation grooves 141a and 141b are formed in the inner diameter portion of the sleeve and the second radial dynamic pressure generation grooves 141c and 141d are formed in the outer diameter portion of the sleeve.

In addition, the first radial dynamic pressure bearing part includes an upper first radial dynamic pressure bearing part and a lower first radial dynamic pressure bearing part formed in the axial direction, and the second radial dynamic pressure bearing part includes an upper second radial dynamic pressure bearing part and a lower second radial dynamic pressure bearing part formed in the axial direction.

In addition, the upper first radial dynamic pressure generation groove 141b and the lower first radial dynamic pressure generation groove 141a are formed so that the upper first radial dynamic pressure bearing part and the lower first radial dynamic pressure bearing part are formed, and the upper second radial dynamic pressure generation groove 141c and the lower second radial dynamic pressure generation groove 141d are formed so that the upper second radial dynamic pressure bearing part and the lower second radial dynamic pressure bearing part are formed.

In addition, an oil circulation hole 143 connecting between the upper first radial dynamic pressure bearing part and the lower first radial dynamic pressure bearing part and between the upper second radial dynamic pressure bearing part and the lower second radial dynamic pressure bearing part is formed.

That is, the oil circulation hole 143 is formed to extend between the upper first radial dynamic pressure generation groove 141b and the lower first radial dynamic pressure generation groove 141a and between the upper second radial dynamic pressure generation groove 141c and the lower second radial dynamic pressure generation groove 141d.

In addition, an outer diameter portion of the sleeve 140 is press-fitted into the base 150, and the armature 160 facing the magnet 130 of the rotating part and including the core 161 and the coil 162 is mounted on the base 150.

Further, the base 160 includes a pulling plate 170 mounted on one surface thereof facing the magnet 130 in order to prevent the rotating part from being floated.

In addition, the cover 180 is mounted at a lower end portion of the sleeve in order to cover a lower portion of the sleeve 140.

Through the above-mentioned configuration, the spindle motor according to the preferred embodiment of the present invention may improve a sealing effect of oil, secure rigidity of the outer diameter portion of the sleeve, and have an efficient hydrodynamic bearing structure.

According to the preferred embodiment of the present invention, it is possible to obtain a hydrodynamic bearing module capable of improving a sealing effect of oil and securing rigidity of an outer diameter portion of a sleeve by forming radial dynamic pressure bearing parts at inner and outer diameter portions of the sleeve, respectively, and forming a thrust dynamic pressure bearing part between the radial dynamic pressure bearing parts and capable of having a more stable and efficient hydrodynamic bearing structure by forming an oil circulation hole between the radial dynamic pressure bearing parts, and a spindle motor having the same.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A hydrodynamic bearing module comprising:
a hydrodynamic bearing part formed by filling oil in a micro-clearance between a rotating part and a fixed part including a sleeve;
a first radial dynamic pressure bearing part formed in a micro-clearance between an inner diameter portion of the sleeve and the rotating part;
a second radial dynamic pressure bearing part formed in a micro-clearance between an outer diameter portion of the sleeve and the rotating part; and
a thrust dynamic pressure bearing part formed between the sleeve and the rotating part and positioned between the first and second radial dynamic pressure bearing parts.

2. The hydrodynamic bearing module as set forth in claim 1, wherein the first radial dynamic pressure bearing part includes an upper first radial dynamic pressure bearing part and a lower first radial dynamic pressure bearing part formed in an axial direction, and
the second radial dynamic pressure bearing part includes an upper second radial dynamic pressure bearing part and a lower second radial dynamic pressure bearing part formed in the axial direction.

3. The hydrodynamic bearing module as set forth in claim 2, further comprising an oil circulation hole connecting between the upper first radial dynamic pressure bearing part and the lower first radial dynamic pressure bearing part and between the upper second radial dynamic pressure bearing part and the lower second radial dynamic pressure bearing part.

4. The hydrodynamic bearing module as set forth in claim 1, wherein the rotating part includes a shaft rotatably supported by the sleeve and a hub coupled to an upper portion of the shaft and positioned to face an upper surface of the sleeve,
the first radial dynamic pressure bearing part is formed in a micro-clearance between the shaft and the sleeve in a radial direction of the shaft and the second radial dynamic pressure bearing part is formed in a micro-clearance between the hub and the sleeve in the radial direction of the shaft, and
the thrust dynamic pressure bearing part is formed in a micro-clearance between the hub and the sleeve in an axial direction of the shaft.

5. A spindle motor having a hydrodynamic bearing module, comprising:
a rotating part including a shaft, a hub coupled to the shaft, and a magnet coupled to the hub; and
a fixed part including an armature facing the magnet and including a core and a coil, a sleeve rotatably supporting the shaft, and a base coupled to the sleeve and having the armature mounted thereon,
wherein the hydrodynamic bearing module includes:
a hydrodynamic bearing formed between the rotating part and the fixed part by filling the oil, which is an operating fluid, therein,
a first radial dynamic pressure bearing part formed in a micro-clearance between an inner diameter portion of the sleeve and the shaft,
a second radial dynamic pressure bearing part formed in a micro-clearance between an outer diameter portion of the sleeve and the hub, and
a thrust dynamic pressure bearing part formed between the sleeve and the hub in an axial direction of the shaft and positioned between the first and second radial dynamic pressure bearing parts.

6. The spindle motor as set forth in claim 5, wherein the first radial dynamic pressure bearing part includes an upper first radial dynamic pressure bearing part and a lower first radial dynamic pressure bearing part formed in the axial direction, and
the second radial dynamic pressure bearing part includes an upper second radial dynamic pressure bearing part and a lower second radial dynamic pressure bearing part formed in the axial direction.

7. The spindle motor as set forth in claim 5, wherein the hydrodynamic bearing module further includes an oil circulation hole connecting between the upper first radial dynamic pressure bearing part and the lower first radial dynamic pressure bearing part and between the upper second radial dynamic pressure bearing part and the lower second radial dynamic pressure bearing part.

8. The spindle motor as set forth in claim 5, wherein the hub includes:
a cylindrical part facing the shaft;
a disk part extended from the cylindrical part in an outer diameter direction;
a sidewall part extended downwardly from an end portion of the disk part in the outer diameter direction in the axial direction of the shaft; and
a sealing part facing an outer diameter portion of the sleeve at the disk part and extended downwardly in the axial direction of the shaft.

9. The spindle motor as set forth in claim 8, wherein the second radial dynamic pressure bearing part is formed in a micro-clearance between the sealing part of the hub and the outer diameter portion of the sleeve.

10. The spindle motor as set forth in claim 5, wherein first radial dynamic pressure generation grooves are selectively formed in the inner diameter portion of the sleeve or an outer diameter portion of the shaft facing the inner diameter portion of the sleeve in order to form the first radial dynamic pressure bearing part.

11. The spindle motor as set forth in claim 9, wherein second radial dynamic pressure generation grooves are selectively formed in the outer diameter portion of the sleeve or the sealing part of the hub facing the outer diameter portion of the sleeve in order to form the second radial dynamic pressure bearing part.

12. The spindle motor as set forth in claim 5, wherein a thrust dynamic pressure generation groove is selectively formed in the sleeve or one surface of the hub facing the sleeve in the axial direction of the shaft in order to form the thrust dynamic pressure bearing part.
